(19) United States
(12) Patent Application Publication
(10) Pub. No.: US 2006/0062362 A1
(43) Pub. Date: Mar. 23, 2006

(54) System and method for server assisted browsing

(76) Inventor: Franklin A. Davis, Newton, MA (US)

Correspondence Address: Hollingsworth & Funk, LLC;Suite 125, 8009 34th Avenue South, Minneapolis, MN, 55425, US

(21) Appl. No.: 10/946,906

(22) Filed: Sep. 22, 2004

(51) Int. Cl. H04M 11/00; H04M 15/06; G06F 15/16

(52) U.S. Cl. 379/100.13; 379/142.14; 709/202

(57) ABSTRACT

A system and method for providing alternate rendering options to legacy browsing terminals is provided. A hosting server modifies existing markup content and provides links to the modified markup content within the frame currently rendered. Control link allows the small screen layout of frame to be rendered onto virtually any browsing terminal. Control link allows rendering of an original image from its corresponding small screen frame.

### FIELD OF THE INVENTION

This invention relates in general to hypertext document navigation, and more particularly, to server assisted hypertext document navigation in mobile devices having limited viewing area and limited resources with which to provide navigation command input.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few.

The essence of mobile browsing lies in its close alignment with widely accepted internet standards. The Wireless Application Protocol (WAP) Forum and the World Wide Web Consortium (W3C) have successfully defined mobile internet standards over the past several years. Just recently, the WAP Forum has adopted the Extensible HyperText Markup Language (XHTML) Basic standard from the W3C as the basis for the latest revision of WAP. Even more recently, style tag additions to XHTML Basic, have yielded XHTML Mobile Profile (MP), thus strengthening the position of the mobile browser in the mainstream Internet to allow for a far greater range of presentation and formatting than previously possible. According to the W3C specification, XHTML MP defines a document type that is rich enough to be used for content authoring and precise document layout, yet can be shared across different classes of devices, such as desktop computers, Personal Digital Assistants (PDA), TV, mobile devices, etc.

Even with the recent technological advances, however, a basic problem persists within the mobile browsing community. In particular, the display size limitation of the mobile device continues to hinder the mobile user's browsing experience. Frame presentation to certain mobile devices, for example, is not practical because of the horizontal and vertical size limitations imposed by the mobile device display. Mobile device access to an HTML frame that has been rendered for a desktop browser, for example, allows only a portion of the frame to be viewed at any given time by the mobile device. Accordingly, navigation throughout the frame entails a series of vertical and horizontal scrolling movements requiring a high degree of interaction by the user.

In order to reduce the amount of interaction by the user, more advanced mobile browsers allow display of an HTML frame in small screen layout, such that the HTML frame is re-formatted into a vertical strip having a width that is equal to the width of the mobile terminal's display. Further, images are scaled to fit within the width of the mobile terminal's display, such that only vertical scrolling movements are required to navigate the entire set of markup content.

Re-formatting in the small screen layout, however, may cause some markup content to lose its original character and meaning. For example, a spread sheet presentation having multiple columns of data extending beyond the width of the mobile terminal's display, is small screen rendered such that the columnar data is wrap text formatted. As such, all columnar detail of the data is lost, thus rendering the small screen format unusable, or at the very best, extremely difficult to read. Other document/presentation formats designed for larger displays pose problems for the mobile display as well. For example, document formats such as Portable Document Format (PDF), Macromedia Flash, Synchronized Multimedia Integration Language (SMIL), Scalable Vector Graphics (SVG), etc. may not allow rendering of the document to fit within the constraints of the mobile device display.

Some of the more advanced mobile browsers that support small screen layout, therefore, also provide a method to request the original layout of the Web page if required. For example, some advanced mobile browsers may send a small screen command to the server to request an adaptation of the Web page for small screen viewing. Once the command is received by the server, the markup content is re-formatted by the server in small screen format prior to transmission to the mobile browser. Conversely, when the mobile browser requires original layout viewing, a command is provided from the mobile browser to the server that requests the original full size view of the Web page, as well as the full size image components of the Web page. Accordingly, the server responds by transmitting the original Web page layout without small screen rendering of the markup content along with the full size images contained within the markup content.

Legacy mobile browsers, however, do not provide such a command set and are, therefore, unable to request either of the original Web page layout or small screen rendering from the server. Further, legacy mobile browsers are unable to request either full size or reduced size images. Some servers are able to discern the capabilities of legacy mobile browsers through the use of context exchanges. In such an instance, although the server may provide an adaptation that matches the mobile terminal's display, the legacy mobile browser remains crippled because it is unable to request the original Web page layout and is further unable to request full size images.

Accordingly, there is a need in the communications industry for a system and method that facilitates advanced rendering options for the legacy mobile browser allowing both small screen/original layout rendering and reduced size/original size object viewing.

### SUMMARY OF THE INVENTION

To overcome limitations in the prior art, and to overcome other limitations that will become apparent upon reading and understanding the present specification, the present invention discloses a system and method for server assisted browsing for modified content rendering onto legacy terminals.

In accordance with one embodiment of the invention, a network browsing system is provided. The network browsing system comprises a network having Web pages addressable by a Uniform Resource Locator (URL), and a terminal coupled to the network. The terminal includes a browser coupled to receive markup content associated with the Web pages. The browser communicates its capabilities to the network. The network browsing system further comprises a hosting server coupled to receive the capabilities and coupled to modify the markup content in accordance with the capabilities. The modifications include additions of links to the modified markup content.

In accordance with another embodiment of the invention, a method for hosting server assisted browsing is provided. The method comprises inserting hosting server generated hyperlinks into original markup content. The hyperlinks define storage locations of modified markup content. The method further comprises accessing the modified markup content through activation of the hyperlinks by a browsing terminal, and providing the modified markup content from the hosting server to the browsing terminal. The modified markup content is generated by the hosting server to correspond to capabilities of the browsing terminal.

In accordance with another embodiment of the invention, a server coupled to a network to provide capability dependent browsing of Web pages hosted by the server is provided. The server comprises means for receiving a Web page request from a first browsing terminal, means for receiving capability definitions associated with the first browsing terminal, means for generating modified content in response to the capability definitions, and means for providing access to the modified content from the requested Web page.

In accordance with another embodiment of the invention, a computer-readable medium having instructions stored thereon which are executable by a hosting server is provided. The instructions perform steps comprising receiving Web page requests from browsing terminals, receiving capability definitions associated with the browsing terminals, generating modified content in response to the capability definitions, and providing access to the modified content from the requested Web page.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary communication system in which the principles of the present invention may be utilized;

FIG. 2 illustrates an exemplary Web page according to the present invention;

FIG. 3 illustrates an exemplary small screen rendition according to the present invention;

FIG. 4 illustrates an alternate small screen rendition according to the present invention;

FIG. 5 illustrates an exemplary small screen rendering of images in accordance with the present invention;

FIG. 6 illustrates the corresponding original size rendering of the small screen image of FIG. 5;

FIG. 7 illustrates an exemplary flow diagram in accordance with the present invention;

FIG. 8 is a representative computing system capable of carrying out server assisted functions according to the present invention; and

FIG. 9 illustrates exemplary interactions between a browsing terminal and a hosting server in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method that provides browsing terminals with the flexibility of controlling the format of rendered content consumed by the browsing terminal. The flexibility is offered by the hosting server of the content, by providing links to the modified content and then placing those links within the original markup. Selection of the links then causes rendering of the modified content as desired by the browsing terminal.

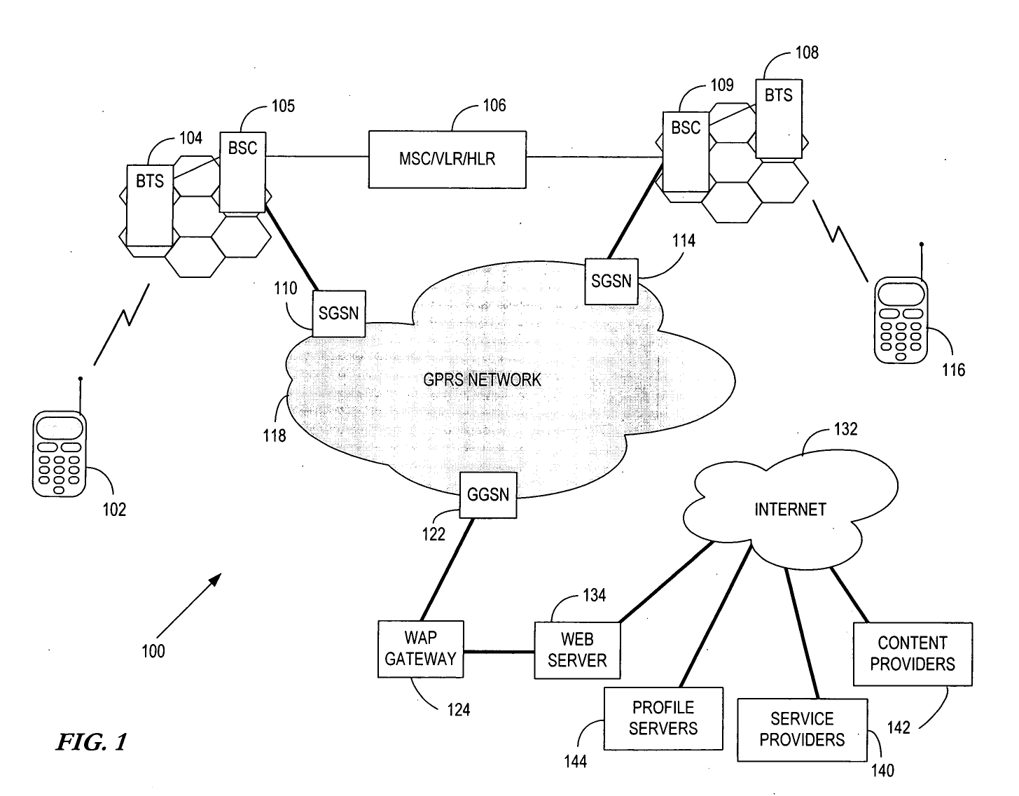

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124. Access to Internet 132 and corresponding service and content providers, 140 and 142 respectively, is provided to mobile terminals 102 and 116 via Web server 134. Profile servers 144 may provide profile information to Internet 132 in relation to hardware/software capabilities pertaining to mobile terminals 102 and 116.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written in Wireless Markup Language (WML) and WMLScript (WMLS) and are stored on either Web server 134 or directly on WAP gateway 124. The content stored on Web server 134 is accessible from mobile devices 102 and 116 via GPRS network 118, GGSN 122, and WAP gateway 124. It is recommended to use a HyperText Transfer Protocol (HTTP) proxy (not shown) to cache WML content whenever the content is accessed via Internet 132. The proxy should either be co-located with WAP gateway 124 or proximately located next to WAP gateway 124 in order to minimize the delay in data transfer between the two components.

Mobile devices 102 and 116 access WAP gateway 124 using a GSM data call, where they supply a user-agent field within a Wireless Session Protocol (WSP) header when fetching content from Web server 134. WAP gateway 124 then encapsulates the WSP header within an HTTP header prior to sending to Web server 134. The WSP header is utilized by Web server 134, for example, to determine the particular browser that is being utilized by mobile devices 102 and 116, so that context dependent content may be delivered to mobile devices 102 and 116 by Web server 134. Beyond the context dependency, however, legacy mobile terminals 102 and 116 lack the ability to further prescribe the format in which the Web page content is to be received.

The present invention, therefore, is useful when URL content to be rendered onto the mobile terminal's display requires more than just context dependent rendering. For example, many of the Web pages, i.e., XHTML/HTML pages, found within Internet 132 of FIG. 1 are mainly designed for larger displays found on desktop computers, fixed Internet terminals, TV monitors, etc. The horizontal and vertical dimensions of these Web pages are usually much larger than Web pages that are specifically designed to fit within the diminutive constraints of a mobile terminal's display. Many of the Web pages can be successfully rendered to fit within the screen size of the mobile terminal by reducing, for example, the resolution or quality of the image or document to be displayed in accordance with the capabilities of the mobile terminal retrieved from, for example, profile servers 144. Other options are available, however, for server assisted rendering of the Web page content. In particular, the server may provide links or objects within the markup content, that allows the browser to select various rendering options of the markup content in accordance with the present invention.

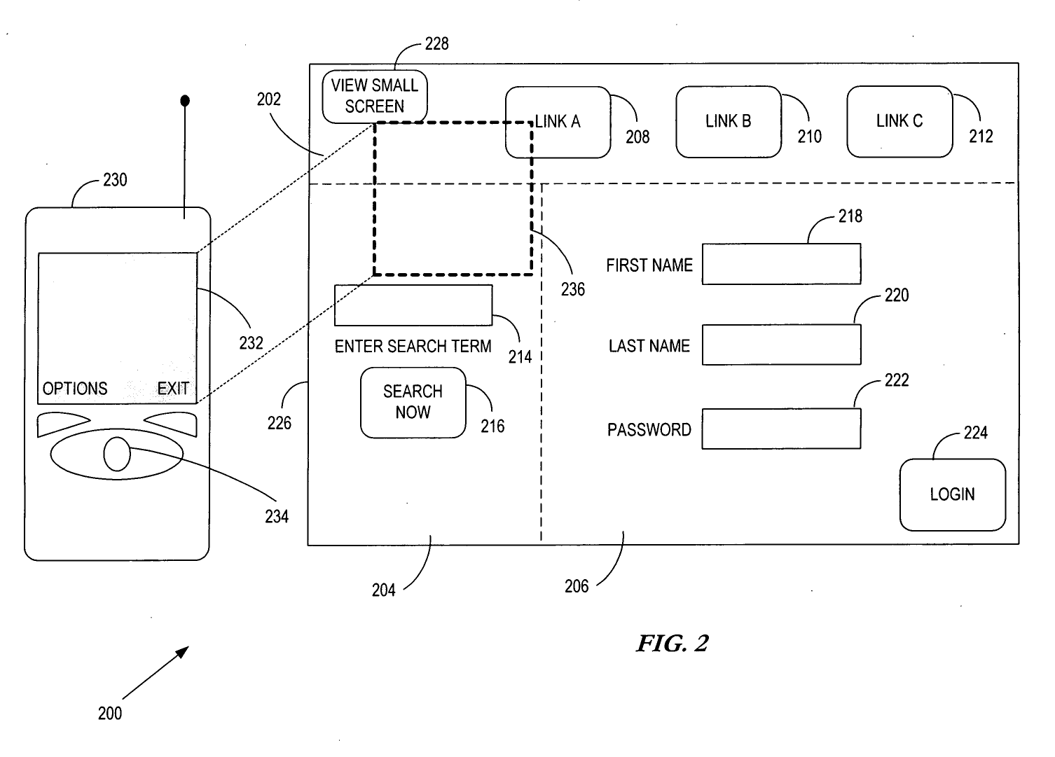

FIG. 2 illustrates an exemplary Web page having, for example, navigational links, e.g., 208-212, control link 228, search fields, e.g., 214-216, and login screens, e.g., 218-224. Screen 226 is partitioned into three areas: 202; 204; and 206. Frame 202 represents an area containing navigational links that may be followed from screen 226. Link A 208, Link B 210, and Link C 212 represent navigational links contained within navigational area 202 such that, when selected, causes the browser to fetch the home page contents of the URL that corresponds to those links.

Frame 204 represents a typical search partition found on many Web pages that allows the user to search for terms that may exist within the URL's domain. Search terms may be entered by the user into input block 214 and then searched for by selecting the “Search Now” button 216. Frame 206 represents a typical login screen partition that allows special users to authenticate themselves by entering their first name in input block 218, their last name in input block 220, and a password in input block 222. Once all of the information is entered, the user's validation may take place by selecting the “Login” button 224.

A typical XHTML code sequence that may be used to define areas 202-206 is presented in code sequence (1) below:

```
<html xmlns=“http://www.w3.org/1999/xhtml”>
<frameset rows=“25%,75%”>
  <frame src=“frame_202.htm” />
  <frameset cols=“40%,60%”>
    <frame src=“frame_204.htm” /> (1)
    <frame src=“frame_206.htm” />
  </frameset>
</frameset>
</html>
```

Code sequence (1) defines two horizontal areas by using the first frameset tag followed by attribute values for each of the two rows in the frame set. The first horizontal area defined by frame 202 claims 25% of the total area of the frameset, whereas the second horizontal area, defined by frames 204 and 206, claims 75% of the total area of the frame set. Within the second of the two horizontal areas, two columns are defined by the second frameset tag by setting attribute values for the two columns, e.g., 204 and 206, of the second horizontal area to 40% and 60%, respectively. Thus, frame 204 comprises 40% of the second horizontal area and frame 206 comprises 60% of the second horizontal area. The contents of each of the framesets defined by code sequence (1) are further defined by HTML files: frame_202.htm; frame_204.htm; and frame_206.htm; and they contain HTML code known in the art to generate frames 202, 204, and 206, respectively. It can be said, therefore, that the three frames defined by code sequence (1) may be opened within the same browser window.

In one embodiment according to the present invention, the Web page illustrated by screen 226 is rendered onto mobile terminal 230 by the Web page's hosting server, e.g., content provider 142 of FIG. 1, in its original layout. In particular, screen 226 does not fit within display 232, but only a portion of screen 226, denoted by portion 236, is displayed at any given time on display 232. The user of mobile terminal 230 navigates through portions of screen 226 by supplying navigational input via, for example, joystick 234.

If frame 236 is the current frame that is rendered to display 232, for example, then a single rightward/leftward actuation of joystick 234 causes frame 236 to scroll one increment to the right/left. Similarly, a single downward/upward actuation of joystick 234 results in scrolling frame 236 by one increment down/up. The definition of a single increment may be predetermined by the user through the use of a configuration menu within mobile terminal 230 to have any number of different meanings. In one embodiment, the user may define an increment to be some fraction of one dimension of display 232. If left/right movements of joystick 234 are actuated, for example, frame 236 may be configured to scroll by 10% of the total horizontal distance defined by screen 226. Alternately, if up/down movements of joystick 234 are actuated, frame 236 may be configured to change by 10% of the total vertical distance defined by screen 226.

The hosting server of the Web page represented by screen 226 may insert control link 228, or any other form of textual/graphical control, into the markup content defined, for example, by “frame_202.htm” as illustrated in code sequence (1) above. In such an instance, the user of mobile terminal 230 may scroll frame 236 such that VIEW SMALL SCREEN link 228 is visible within display 232. The user may then actuate link 228 through any number of control features found on mobile terminal 230. For example, the user may actuate VIEW SMALL SCREEN link 228 by a single depression of joystick 234.

Once VIEW SMALL SCREEN link 228 has been actuated by the user of mobile terminal 230, screen 226 is re-formatted by the hosting server into small screen viewing mode. In one embodiment according to the present invention, the hosting server gains profile information that is associated with the hardware/software capabilities of mobile terminal 230, so that customized re-formatting may be accomplished in accordance with the capabilities of mobile terminal 230. Profile information may be accessed in any number of ways including profile information exchange between the hosting server and a profile server via, e.g., the User Agent Profile (UAProf) specification. In other embodiments according to the present invention, the mobile terminal itself may transfer its own capability information within either of and SMS or MMS message. Alternatively, a Session Initiation Protocol (SIP) exchange using the OPTIONS method may be initiated by the hosting server to receive the mobile terminal capability information. It should be noted that the capabilities exchange between the mobile terminal and the hosting server may take place at any time. The capabilities may be exchanged early into the browsing session, for example, or conversely only exchanged after activation of control link 228.

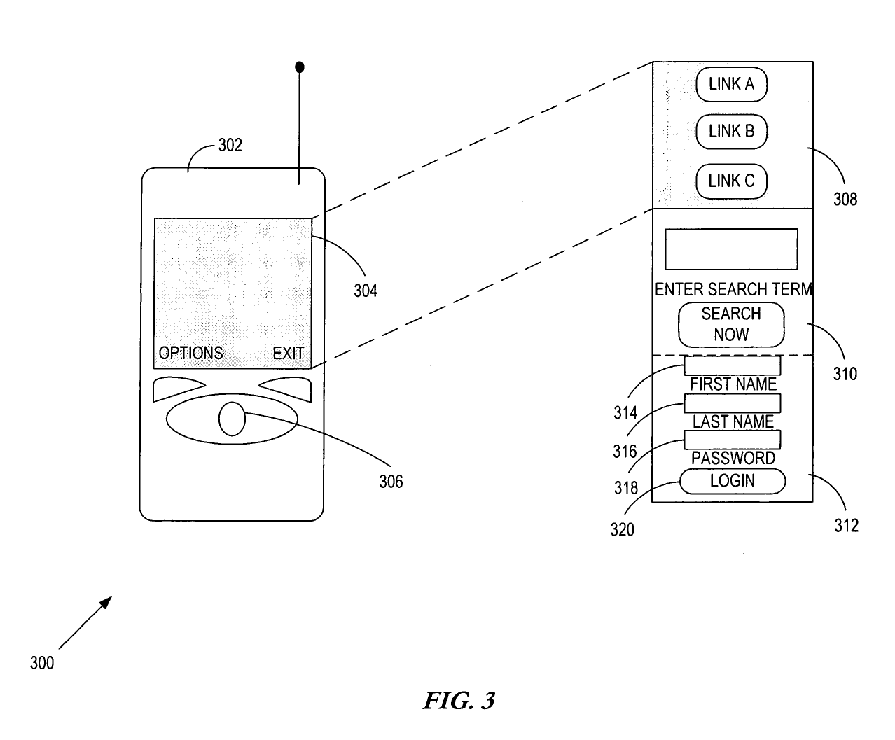

FIG. 3 illustrates exemplary small screen rendition 300 of the original Web page layout as displayed by frame 226 of FIG. 2. Small screen rendition 300 is generated by the hosting server from the markup content that is exemplified by code sequence (1) above in response to user activation of link VIEW SMALL SCREEN 228. In order to generate small screen rendition 300, the hosting server dispenses with the “frameset” tags of code sequence (1) and instead accesses the markup language contained within HTML files “frame_202.htm”, “frame_204.htm” and “frame_206.htm”. All markup content contained within the HTML files is then re-formatted to be fully displayed in vertical mode as illustrated by small screen rendition 300.

In particular, frame 308 corresponds to frame 202 of FIG. 2, whereby object links 208-212 have been reduced in size and stacked vertically by the hosting server, so that they fit within frame 308. The dimensions of frame 308 are pre-determined by the hosting server in accordance with the profile information associated with mobile terminal 302 previously received. Similarly, frames 310 and 312, corresponding to frames 204 and 206 of FIG. 2, are generated by the hosting server such that the markup content defined within files “frame_204.htm” and “frame_206.htm” may be fully contained by frames 310 and 312, respectively.

Once re-formatted, small screen rendition 300 may be subsequently navigated by the user of mobile terminal 302 through, for example, successive actuations of joystick 306. The user need only provide vertical stimulus to joystick 306 in order to view frames 308-312. Assuming that frame 308 is the default frame currently rendered onto display 304, for example, the user may pre-select frame 310 through a single downward actuation of joystick 306. Once pre-selected, frame 310 is then rendered onto display 304. Similarly, a subsequent downward actuation of joystick 306 causes frame 312 to be rendered onto display 304.

Once pre-selected, the user may activate the frame, for example, by a single depression of joystick 306. If, for example, frame 312 is currently activated by joystick depression, then subsequent vertical actuations of joystick 306 causes the mobile browser of mobile terminal 302 to pre-select the various objects contained within frame 312. Object 314 may then be highlighted indicating that object 314 is the default, pre-selected object within frame 312. If the user wishes to enter his first name, for example, then the user depresses joystick once to enter into a text input session to populate text box 314. If, on the other hand, the user wishes to enter a password, then two downward actuations of joystick 306 causes object 318 to be highlighted, indicating its pre-selected status. A subsequent depression of joystick 306 then instantiates a text input session to populate text box 318.

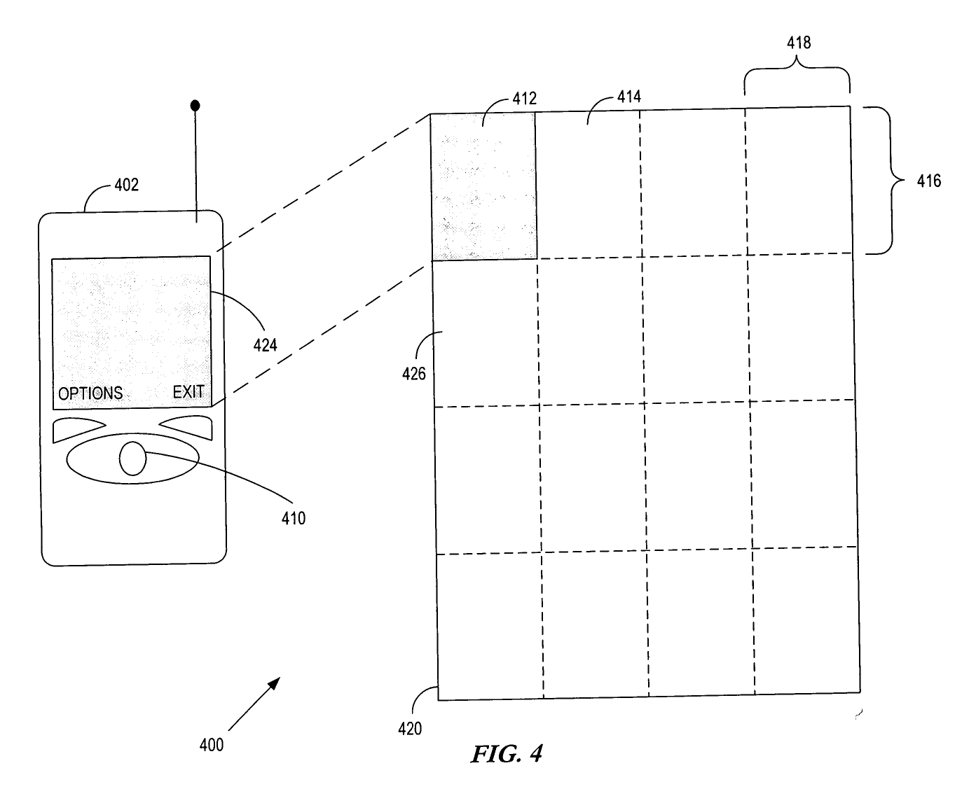

In another embodiment according to the present invention, selection of VIEW SMALL SCREEN link 228 may cause the hosting server to re-format the Web page in accordance with alternate small screen format 400 of FIG. 4. Alternate small screen format 400 renders XHTML document 420 into, for example, 16 sub-components, or frames, 414 of equal, or near equal, dimension. Width dimension 418 and height dimension 416 are sufficiently arranged to “fit” within display 424, in accordance with pre-determined profile information associated with mobile terminal 402, such that the content of the sub-components of XHTML document 420 may be adequately displayed to be coherent and easily understood.

Navigation between frames 414 may be facilitated through the use of joystick 410 of mobile terminal 402. If frame 412 is the current frame that is rendered onto display 424, for example, then a single rightward actuation of joystick 410 causes the mobile browser to display the contents of frame 414. Similarly, a single downward actuation ofjoystick 410 results in the rendering of frame 426 onto display 424. Once the user has located a frame of interest, a single depression of joystick 410 results in activation of the frame in preparation for navigation within the activated frame as discussed above.

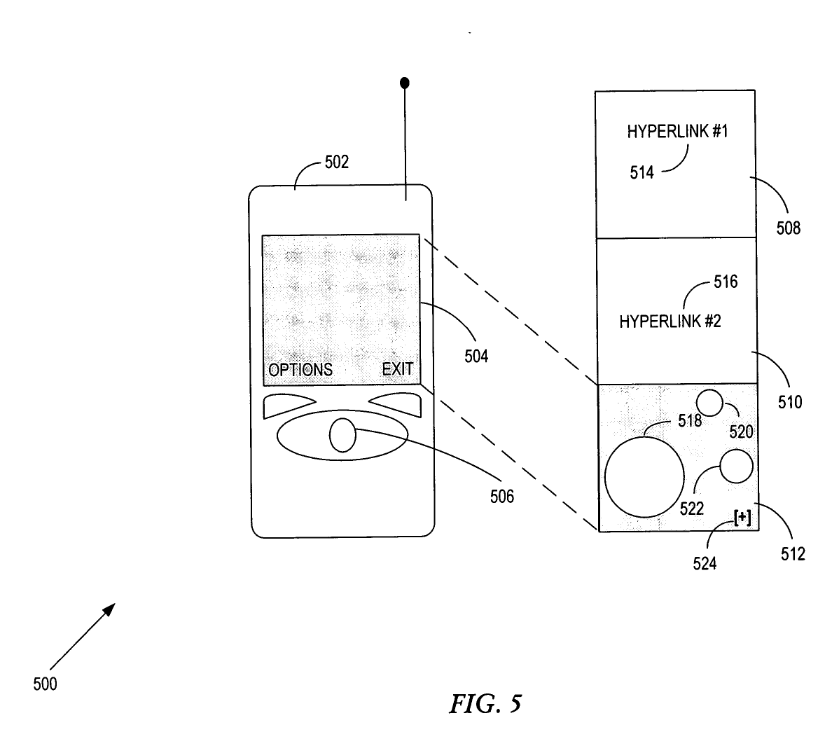

FIG. 5 illustrates content 500 that has been previously formatted by a hosting server, e.g., content provider 142 of FIG. 1, into small screen format having small screen frames 508-512. Content 500 contains hyperlinks 514 and 516, as well as image map 512 having hot spot regions 518-522 defined within. In addition, image map 512 includes link [+] 524, installed by the hosting server prior to rendering onto mobile terminal 502, which provides the user of mobile terminal 502 with the ability to command the hosting server to generate a full size rendition of image map 512 in accordance with the present invention.

An exemplary code sequence that generates the hyperlinks and hot spots displayed by content 500 is illustrated in code sequence (2). It can be seen that each hyperlink 514 and 516 is established with an anchor tag, i.e., “a” tag, that is used to create an anchor from frame 508 and 510, respectively, and an “href” attribute used to address the document which is being linked, e.g., HYPERLINK #1 links to “http://www.hyperlink1.com/” and HYPERLINK #2 links to “http://www.hyperlink2.com/”. Similarly, image map 512 is created having, for example, images of the sun 518, mercury 520, and venus 522, where each planet/star image is itself a hyperlink, e.g., href=“./images/planets/sun.htm” creates a hyperlink to the file that defines the image of the sun. Image shapes are defined in code sequence (2) through the use of the “area” tag, whereby the attributes of the shapes are further defined by the

<!DOCTYPE html (2)
PUBLIC “-//W3C//DTD XHTML 1.0 Strict//EN”
“http://www.w3.org/TR/xhtml1/DTD/xhtml1-strict.dtd”>
<html>
<body>
<p>
<a href=“http://www.hyperlink1.com/”>
HYPERLINK #1</a>
</p>
<p>
<a href=“http://www.hyperlink2.com/”>
HYPERLINK #2</a>
</p>
<img src=“../images/circles.gif”
width=“125” height=“145”
usemap=“#planetmap”>
<map id=“planetmap” name=“planetmap”>
<area shape=“rect”
coords=“0,0,82,126”
alt=“Sun”
href=“../images/planets/sun.htm”>
<area shape=“circle”
coords=“90,58,3”
alt=“Mercury”
href=“../images/planets/mercur.htm”>
<area shape=“circle”
coords=“124,58,8”
alt=“Venus”
href=“../images/planets/venus.htm”>
</map>
</body>
</html>

The hosting server then modifies code sequence (2) so that markup language corresponding to link [+] 524 is added. Exemplary markup language for the link is illustrated in code sequence (3).

<p> (3)
<a href=“http://www.full_size.com/”>
[+]</a>
</p>

Hyperlink 524, therefore, is established by the hosting server with an anchor tag that is used to create an anchor from frame 512, and an “href” attribute used to address the document which is being linked, e.g., [+] links to “http://www.full_size.com/”. In particular, “http://www.full_size.com/” contains markup content that is similar to code sequence (2), except that the attributes of the shapes contained within image map 512 are enlarged.

Enlargement of the area shape for mercury, for example, may be implemented by the hosting server by editing the “coords=<Center X>, <Center Y>, <Radius>” portion of the attributes defining the shape of mercury, e.g., coords=“90, 58, 3”. The third entry associated with the attribute “coords” for mercury in code sequence (2) indicates that the radius of the circle that corresponds to the planet mercury is rendered in small screen mode with a radius of “3”. The hosting server, therefore, need only increase the radius from “3” to some other number larger than “3” to increase the radius of mercury to its original size.

Similarly, the hosting server re-formats the other shapes of image map 512 by creating alternate attribute definitions for the remaining “coords” attributes, such that the images contained within image map 512 may be rendered into their original size representation. Additionally, the files defining the image details, e.g., href=“./images/planets/mercur.htm”, may also be modified by the hosting server in accordance with the enlarged attributes of their associated shapes.

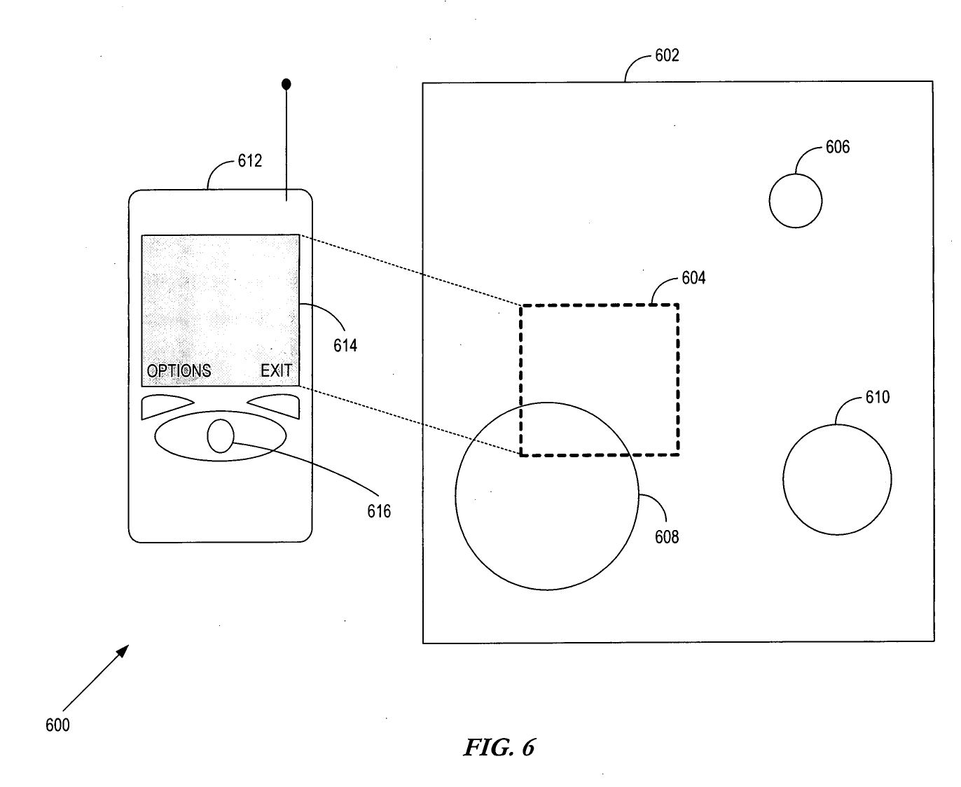

Subsequent activation of link [+] 524 by the user of mobile terminal 502 may be accomplished, for example, through various actuations of joystick 506 as discussed above. Once activated, the hosting server renders image map 512 of FIG. 5 into full size image map 600 as illustrated in FIG. 6. Images 606-610 have been enlarged by the re-formatting process as discussed above and frame 604 represents the viewable image as projected onto display 614 of mobile terminal 612. The user of mobile terminal 612 is then able to navigate throughout frame 602 by subsequent actuations of joystick 616 as discussed above.

It should be noted that the HTML frame enhancement features according to the present invention may be accomplished by virtually any browser, whether it be mobile or land based. That is to say, that virtually any legacy terminal, regardless of its individual capabilities, may enjoy the advantages of the present invention by simply selecting the HTML frame enhancement links offered by their corresponding hosting servers.

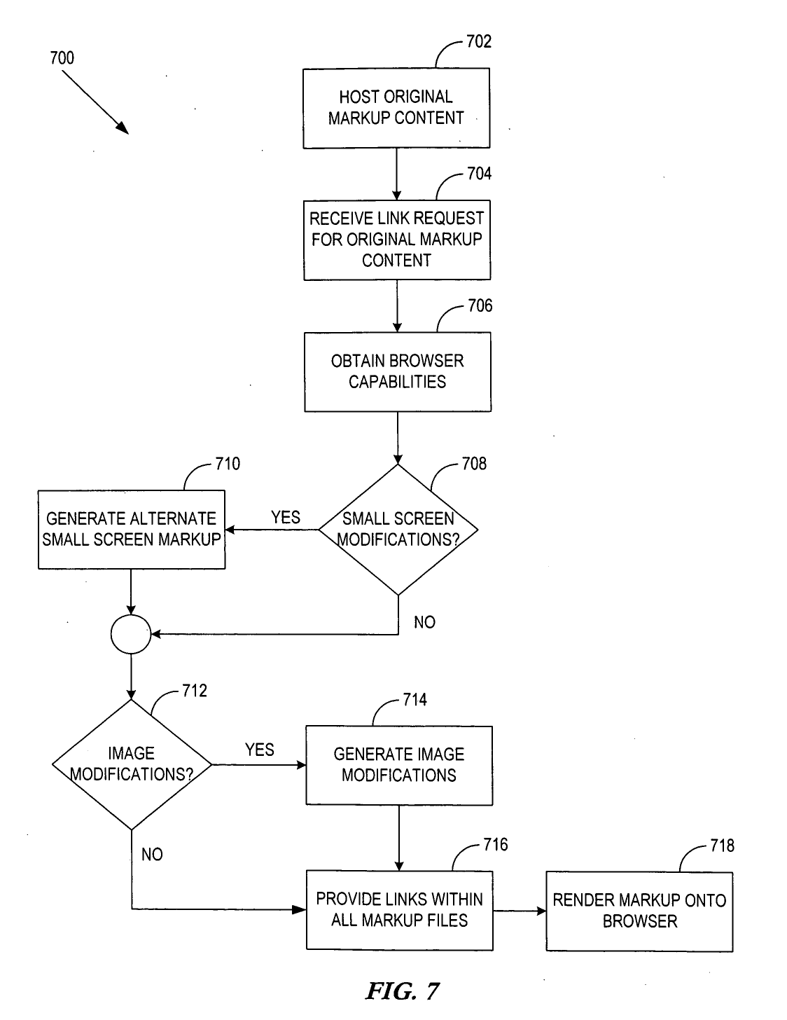

A method according to the principles of the present invention is illustrated by exemplary flow diagram 700 of FIG. 7. In step 702, a hosting server, e.g., content provider 142 of FIG. 1, is responsible for hosting markup content, whereby the markup content is made available to virtually any browser within, e.g., Internet 132. Link requests for the hosted content are received by the hosting server from Internet 132 as in step 704.

A browser capability exchange may be implemented in step 706, whereby the capabilities of the requesting browser are ascertained by the hosting server as discussed above. If the hosting server ascertains in step 708 that small screen modifications may be implemented in accordance with the received browser capabilities, then alternate small screen markup is generated in step 710. Exemplary small screen markup as illustrated by FIGS. 3-5 provide exemplary small screen markup options, but it is apparent to one of ordinary skill in the art that virtually endless options exists for small screen markup modifications.

Generally speaking, two types of links are placed by the hosting server. First, link 228 of FIG. 2, for example, represents a link to newly generated small screen markup as illustrated in FIG. 3 that may be rendered by virtually any browser located within Internet 132. Other small screen markup options exist, such as the alternate small screen format as illustrated in FIG. 4. Second, link 524 of FIG. 5 allows original image rendering, e.g., frame 602 of FIG. 6, from its corresponding small screen format, e.g., frame 512 of FIG. 5. If image modifications are required, then they are performed as in step 714. Once all of the content modifications have been implemented, their corresponding links are placed into the rendered frames as in step 716. The entire content, including newly added control links, is then rendered onto the browsing terminal as in step 718.

It should be noted that the order of execution steps as illustrated in FIG. 7 illustrates an exemplary order of execution. It is to be understood that other execution sequences are possible and that the order illustrated by FIG. 7 is not meant to be limiting in any way. For example, the hosting server may generate small screen renditions of original markup content, as well as full size renditions of small screen objects, through default operation on its hosted content. The hosting server may, for example, maintain various copies of modified content, the content of which is based on a number of browser capabilities currently serviced by the hosting server.

In such an instance, the hosting server may maintain a copy of content that is adapted for consumption by a desktop device, for example, while also maintaining the corresponding content that is meant for consumption by a mobile terminal having a 128×160 pixel display. The capability information may be exchanged within an HTTP header, for example, during step 706, whereby the hosting server realizes that modified markup content has already been generated for the requesting browser. Accordingly, the hosting server may bypass steps 708-716 and immediately render the markup content onto the browsing terminal as in step 718. The ability to cache a multiplicity of renditions of content based upon more popular browsing terminal configurations, serves to increase the speed at which the popular terminals may browse the hosting server's content, since the content has been pre-modified.

In another embodiment according to the present invention, the option of pre-generating small screen modifications from original screen layout, or generating original size objects from small screen renditions, may be requested by the browsing terminal. For example, a variable contained within the configuration/profile information of the browsing terminal as obtained in step 706 may direct the hosting server to perform the markup modifications as necessary. Once the markup modifications have been performed by the hosting server, the newly modified content may then be cached in preparation for subsequent content requests from other browsing terminals having similar characteristics.

In another embodiment according to the present invention, the modifications may be performed by the hosting server only when the corresponding link to the desired modified content is activated by the browsing terminal. In such an instance, steps 716 and 718 are performed first by the hosting server, whereby only the links to the modified content files are supplied by the hosting server. No actual markup modifications are performed until the links to the modified content files are activated by the browsing terminal, in which case steps 706-714 may then be executed. Once modified content is generated, it may then be cached for subsequent content requests from compatible browsing terminals.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a browsing system, apparatus, and method in accordance with the present invention.

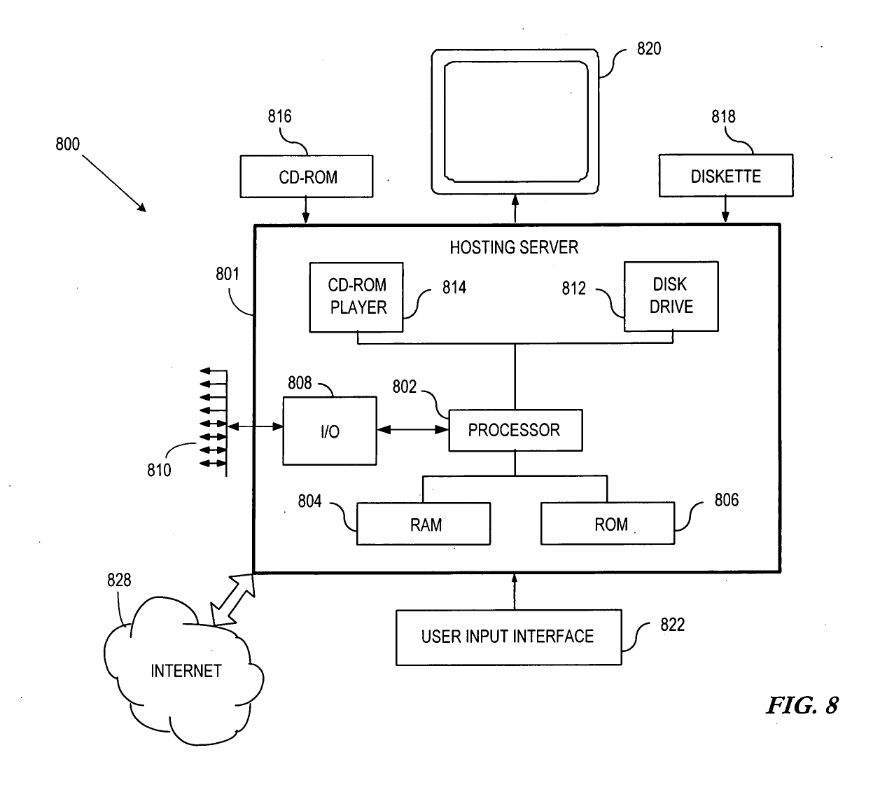

The hosting servers or other systems for providing server functions in connection with the present invention may be any type of computing device capable of processing and communicating digital information. The server platforms utilize computing systems to control and manage the markup modification activity. An example of a representative computing system capable of carrying out operations in accordance with the invention is illustrated in FIG. 8. Hardware, firmware, software or a combination thereof may be used to perform the various hosting functions and operations described herein. The computing structure 800 of FIG. 8 is an example computing structure that can be used in connection with such a hosting platform.

The example computing arrangement 800 suitable for performing the hosting activity in accordance with the present invention includes hosting server 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, data received from I/O connections 808 or Internet connection 828 may be processed in accordance with the present invention. External data storage devices, such as profile/capability servers, may be coupled to I/O circuitry 808 to facilitate hosting functions according to the present invention. Alternatively, such databases may be locally stored in the storage/memory of assistance server 801, or otherwise accessible via a local network or networks having a more extensive reach such as the Internet 828. The processor 802 carries out a variety of functions as is known in the art, as dictated by software and/or firmware instructions.

Hosting server 801 may also include one or more data storage devices, including hard and floppy disk drives 812, CD-ROM drives 814, and other hardware capable of reading and/or storing information such as DVD, etc. Disk drives 812 may, for example, provide storage cache for previously modified content for future content requests from terminals having capabilities that are compatible with the previously modified content. In one embodiment, software for carrying out the hosting operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to assistance server 801 via data signals, such as being downloaded electronically via a network, such as the Internet. Hosting server 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

Hosting server 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

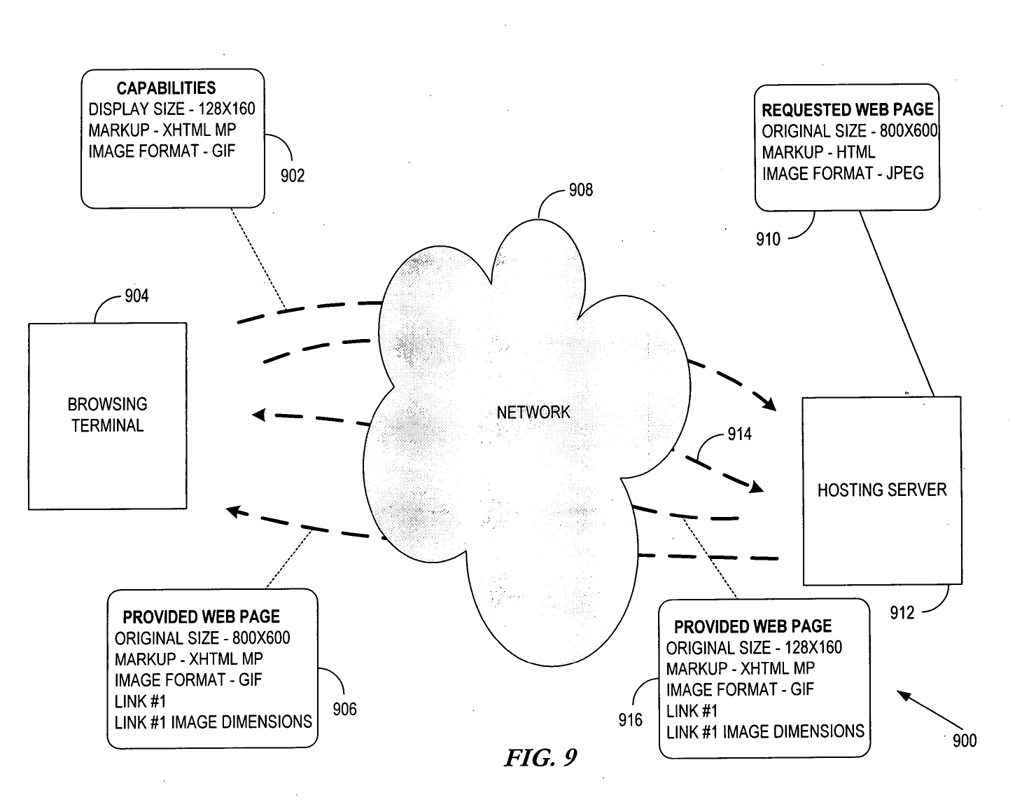

The hosting server, in accordance with the present invention, may also provide other functions that assist a terminal during an exemplary browsing session as illustrated by FIG. 9. FIG. 9 illustrates exemplary interaction 900 between browsing terminal 904 and hosting server 912 during a server assisted browsing session. Message 902 illustrates a combination of a capabilities exchange along with a Web page request from browsing terminal 904 to hosting server 912. Network 908 is the conduit used for such an exchange and is, for example, illustrated by communication system 100 of FIG. 1.

In particular, the capabilities reported by browsing terminal 904 include, but are not limited to: display size information, e.g., 128×160 pixels; XHTML MP markup language compatibility; and Graphics Interchange Format (GIF) support. Such capabilities information may have been provided by browsing terminal 904 within, for example, an “Accept” header field within an HTTP request for Web page 910 hosted by hosting server 912. The corresponding attributes pertaining to requested Web page 910 include, but are not limited to: original content rendering for an 800×600 pixel display; HTML markup language; and Joint Photographic Experts Group (JPEG) image format.

Response 906 is generated by hosting server 912 in response to the request for Web page 910. Response 906 contains the original rendition of the requested Web page in an 800×600 pixel layout, however, the markup language has been converted by hosting server 912 from, e.g., HTML, to that supported by browsing terminal 904, e.g., XHTML MP as reported in capabilities information 902. Similarly, hosting server 912 has converted the image format type of requested Web page 910 from, e.g., JPEG, to that supported by browsing terminal 904, e.g., GIF.

Once the requested Web page is received by browsing terminal 904, the browser within browsing terminal 904 renders the 800×600 image onto its display, as illustrated for example, by FIG. 2. Contained within the displayed Web page, e.g., 226 of FIG. 2, is Link #1 of response 906, which corresponds to, for example, control link 228 of FIG. 2. Also contained within response 906, are the reduced image dimensions and placement coordinates for the reduced size image contained within the small screen markup that is addressed by Link #1. By providing not only Link #1, but also placement and dimension information of images contained within Link #1, browsing terminal 904 is able to immediately render content defined by Link #1 with the correct amount of space reserved for the reduced size image. The resultant rendering is exemplified by small screen format 300 of FIG. 3, where the placement of frames 308-312 have been assisted by hosting server 912, in part, by providing the placement and dimension information pertaining to the images contained within small screen format 300, e.g., LINK A, of frame 308.

An alternate mode of assistance provided by hosting server 912 in accordance with the present invention is exemplified in the message exchange 914 and 916 between browsing terminal 904 and hosting server 912. In message 914, browsing terminal 904 has initiated an HTTP request similar to message 902, whereby not only the requested Web page URL, but also the capability information concerning browsing terminal 904, is provided. In this case, the requested Web page has previously been requested by a browsing terminal whose capabilities match those reported by browsing terminal 904 in message 914. Accordingly, hosting server 912 has previously cached a small screen rendition of the Web page requested by browsing terminal 904. As such, hosting server 912 recalls the small screen rendition of the Web page from its cache and provides it to browsing terminal 904 within response message 916.

The small screen rendition supplied to browsing terminal 904 by hosting server 912 may be exemplified by content 500 of FIG. 5. Also provided within response 916 is Link #1, which corresponds, for example, to control link 524 of FIG. 5. Also contained within response 916, are the enlarged image dimensions and placement coordinates for the enlarged image contained within the original layout that is addressed by Link #1. By providing not only Link #1, but also placement and dimension information of images contained within Link #1, browsing terminal 904 is able to immediately render content defined by Link #1 with the correct amount of space reserved for the full size image. The resultant rendering is exemplified by full size image map 600 of FIG. 6, where the placement of frame 602 has been assisted by hosting server 912, in part, by providing the placement and dimension information pertaining to the images contained within full size image map, e.g., the image of sun 608.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A network browsing system, comprising:
a network having Web pages addressable by a Uniform Resource Locator (URL);
a terminal coupled to the network, the terminal including a browser coupled to receive markup content associated with the Web pages, wherein the browser communicates its capabilities to the network; and
a hosting server coupled to receive the capabilities and coupled to modify the markup content in accordance with the capabilities, wherein the modifications include additions of links to the modified markup content.

2. The network browsing system according to claim 1, wherein the browser capabilities include display characteristics of the terminal.

3. The network browsing system according to claim 2, further comprising a profile server coupled to the network to store the browser capabilities.

4. The network browsing system according to claim 1, wherein the terminal communicates the capabilities to the hosting server.

5. The network browsing system according to claim 2, wherein the modified markup content includes small screen content arranged to fit within a width dimension in accordance with the display characteristics of the terminal.

6. The network browsing system according to claim 5, wherein the small screen content includes a link to an original size image proportionate in size to the reduced size image.

7. A method for hosting server assisted browsing, comprising:
inserting hosting server generated hyperlinks into original markup content, wherein the hyperlinks define storage locations of modified markup content;
accessing the modified markup content through activation of the hyperlinks by a browsing terminal; and
providing the modified markup content from the hosting server to the browsing terminal, wherein the modified markup content is generated by the hosting server to correspond to capabilities of the browsing terminal.

8. The method according to claim 7, wherein the capabilities of the browsing terminal are provided by a profile server coupled to the hosting server.

9. The method according to claim 7, wherein the capabilities of the browsing terminal are provided by the browsing terminal to the hosting server.

10. The method according to claim 9, further comprising generating modified markup content having reduced dimensions that are compatible with dimensions of a display of the browsing terminal.

11. The method according to claim 10, wherein a first hyperlink to the modified content having reduced dimensions is provided within the original markup content.

12. The method according to claim 11, wherein a second hyperlink is provided within the modified content having reduced dimensions, the second hyperlink defining a storage location of a full size rendition of an image contained within the content having reduced dimensions.

13. A server coupled to a network to provide capability dependent browsing of Web pages hosted by the server, the server comprising:
means for receiving a Web page request from a first browsing terminal;
means for receiving capability definitions associated with the first browsing terminal;
means for generating modified content in response to the capability definitions; and
means for providing access to the modified content from the requested Web page.

14. The server according to claim 14, further comprising means for caching the modified content.

15. The server according to claim 14, further comprising means for recalling the cached content in response to receiving a Web page request from a second browsing terminal having capabilities substantially equivalent to the first browsing terminal.

16. A computer-readable medium having instructions stored thereon which are executable by a hosting server by performing steps comprising:
receiving Web page requests from browsing terminals;
receiving capability definitions associated with the browsing terminals;
generating modified content in response to the capability definitions; and
providing access to the modified content from the requested Web page.

17. The computer-readable medium according to claim 16 further comprising instructions to perform steps comprising caching modified content generated for a first browsing terminal.

18. The computer-readable medium according to claim 17 further comprising instructions to perform steps comprising recalling the content modified for the first terminal in response to receiving a Web page request from a second browsing terminal having capabilities substantially equivalent to the first browsing terminal.
